(19) United States
(12) Patent Application Publication
(10) Pub. No.: US 2026/0205017 A1
(43) Pub. Date: Jul. 16, 2026

(54) FLYBACK POWER CONVERSION CIRCUIT OPERATING IN ZERO-VOLTAGE SWITCHING AND CONTROL METHOD THEREOF

(71) Applicant: Richtek Technology Corporation, Zhubei City (TW)

(72) Inventors: Ta-Yung YANG, Taoyuan City (TW); Li-Di LO, Taichung City (TW); Kun-Yu LIN, Zhubei City (TW); Tzu-Chen LIN, Zhubei City (TW)

(21) Appl. No.: 19/403,512

(22) Filed: Nov. 28, 2025

Related U.S. Application Data
(60) Provisional application No. 63/745,398, filed on Jan. 15, 2025.

(30) Foreign Application Priority Data
Sep. 12, 2025 (TW) 114135097

(51) Int. Cl. H02M 3/335; H02M 1/00

(52) U.S. Cl. CPC H02M 3/33569; H02M 1/0009; H02M 1/0058

(57) ABSTRACT

A power conversion circuit includes a transformer, a switching transistor, an auxiliary transistor, and a control circuit. The transformer includes a primary coil, a secondary coil, and an auxiliary coil. The primary coil receives an input voltage, and the secondary coil generates an output voltage. The switching transistor is coupled between the primary coil and a ground. The auxiliary transistor is coupled between a terminal of the auxiliary coil and the ground. The control circuit drives the switching transistor based on the output voltage. When the transformer ends the demagnetization, the control circuit turns on the auxiliary transistor in a zero-voltage switching period, so that the switching transistor achieves zero-voltage switching when the switching transistor is turned on once again.

### CROSS REFERENCE TO RELATED APPLICATIONS

This application claims the benefit of U.S. Provisional Application No. 63/745,398, filed on Jan. 15, 2025, the entirety of which is incorporated by reference herein.

This application claims priority of Taiwan Patent Application No. 114135097, filed on Sep. 12, 2025, the entirety of which is incorporated by reference herein.

### BACKGROUND OF THE INVENTION

### Field of the Invention

The disclosure is generally related to a power conversion circuit and a control method thereof, and more particularly it is related to a flyback power conversion circuit operating in zero-voltage switching and a control method thereof.

### Description of the Related Art

Flyback power converters are isolated power conversion circuits and are one of the most widely used power supply architectures. Their low cost due to the minimal number of components is one of the reasons for their widespread adoption. However, traditional flyback power converters operate on hard switching, resulting in poor conversion efficiency and high electromagnetic interference (EMI). Therefore, it is necessary to operate flyback power converters on zero-voltage switching to increase conversion efficiency and reduce EMI.

### BRIEF SUMMARY OF THE INVENTION

A zero-voltage switching flyback power conversion circuit and its control method is provided herein. By turning on the auxiliary transistor, a negative current is generated in the primary coil, thereby reducing the drain voltage to zero. Furthermore, this invention further determines the timing for turning on the switching transistor once again by monitoring the voltage level of the auxiliary voltage generated by the auxiliary coil, thus ensuring that zero-voltage switching is achieved when the switching transistor is turned on. Moreover, this invention can adjust the conduction time of the auxiliary transistor by monitoring the voltage level of the auxiliary voltage before the switching transistor is turned on, thereby ensuring that the switching transistor achieves zero-voltage switching.

In an embodiment, a power conversion circuit comprises a transformer, a switching transistor, an auxiliary transistor, and a control circuit. The transformer comprises a primary coil, a secondary coil, and an auxiliary coil, wherein the primary coil receives an input voltage, and the secondary coil generates an output voltage. The switching transistor is coupled between the primary coil and a ground. The auxiliary transistor is coupled between a terminal of the auxiliary coil and the ground. The control circuit drives the switching transistor based on the output voltage. When the transformer ends demagnetization and a predetermined delay period is passed, the control circuit turns on the auxiliary transistor in a zero-voltage switching period so that the switching transistor achieves zero-voltage switching when the switching transistor is turned on once again.

According to an embodiment of the present invention, an auxiliary voltage is generated between the auxiliary coil and the auxiliary transistor. The control circuit determines whether the auxiliary voltage after the zero-voltage switching period ends and a delay period is passed is close to the auxiliary voltage when the switching transistor is turned on. When the auxiliary voltage after the zero-voltage switching period ends and the delay period is passed close to the auxiliary voltage when the switching transistor is turned on, the control circuit maintains the length of the zero-voltage switching period. When the auxiliary voltage after the zero-voltage switching period ends and the delay period is passed is not close to the auxiliary voltage when the switching transistor is turned on, the control circuit adjusts the length of the zero-voltage switching period.

According to an embodiment of the present invention, when the auxiliary voltage exceeds an upper threshold voltage, the control circuit extends the zero-voltage switching period. When the auxiliary voltage does not exceed a lower threshold voltage, the control circuit shortens the zero-voltage switching period. When the auxiliary voltage is between the upper threshold voltage and the lower threshold voltage, the control circuit maintains the zero-voltage switching period.

According to an embodiment of the present invention, the power conversion circuit further comprises a current detection resistor, a secondary control circuit, and an optocoupler. The current detection resistor is coupled between the switching transistor and the ground. The secondary control circuit generates a feedback current based on the output voltage. The optocoupler generates a feedback signal based on the feedback current. A current from the input voltage flowing through the primary coil and the switching transistor flows through the current detection resistor to generate a current detection signal. The control circuit turns on or off the switching transistor based on a relationship between the feedback signal and the current detection signal.

According to an embodiment of the present invention, when the feedback signal is lower than a first threshold voltage, the control circuit extends the predetermined delay period.

According to an embodiment of the present invention, when the auxiliary voltage rises to exceed a second threshold voltage, the control circuit begins delaying the predetermined delay period.

According to an embodiment of the present invention, when the feedback signal is less than a third threshold voltage, the control circuit ends the zero-voltage switching period. When output power of the output voltage falls, the feedback signal falls accordingly.

According to an embodiment of the present invention, the control circuit determines whether the auxiliary voltage is in a valley after the predetermined delay period is passed. When the control circuit determines that the auxiliary voltage is in the valley, the control circuit begins the zero-voltage switching period. When the control circuit does not determine that the auxiliary voltage is in the valley in a delay period after the predetermined delay period, the control circuit begins the zero-voltage switching period after the delay period ends.

According to an embodiment of the present invention, when the auxiliary voltage is less than a fourth threshold voltage, the control circuit determines that the auxiliary voltage is in the valley.

According to an embodiment of the present invention, the other terminal of the auxiliary coil generates a supply voltage. The supply voltage is configured to power the control circuit. When the transformer demagnetizes, the secondary coil powers the output voltage and the control circuit turns on the auxiliary transistor, so that the auxiliary coil powers the supply voltage. The supply voltage is the output voltage multiplied by a turns ratio. The turns ratio is a number of turns of the auxiliary coil divided by a number of turns of the secondary coil.

According to an embodiment of the present invention, the power conversion is a flyback power conversion circuit.

In another embodiment, a control method for controlling a power conversion circuit is provided. The power conversion circuit comprises a transformer, a switching transistor, and an auxiliary transistor. The transformer comprises a primary coil receiving an input voltage, a secondary coil generating an output voltage, and an auxiliary coil. The switching transistor is coupled between the primary coil and a ground, wherein the auxiliary transistor is coupled between a terminal of the auxiliary coil and the ground. The control method comprises: turning on the switching transistor to magnetize the transformer; turning off the switching transistor to demagnetize the transformer; and after the transformer ends demagnetization and a predetermined delay period is passed, turning on the auxiliary transistor in a zero-voltage switching period so that the switching transistor achieves zero-voltage switching when the switching transistor turns on once again.

According to an embodiment of the present invention, an auxiliary voltage is generated between the auxiliary coil and the auxiliary transistor. The control method further comprises: determining whether the auxiliary voltage after the zero-voltage switching period ends and a delay period is passed is close to the auxiliary voltage when the switching transistor turns on; when the auxiliary voltage after the zero-voltage switching period ends and the delay period is passed is close to the auxiliary voltage when the switching transistor turns on, maintaining a length the zero-voltage switching period; and when the auxiliary voltage after the zero-voltage switching period ends and the delay period is passed is not close to the auxiliary voltage when the switching transistor turns on, adjusting the length of the zero-voltage switching period.

According to an embodiment of the present invention, the control method further comprises: comparing the auxiliary voltage with an upper threshold voltage and a lower threshold voltage; when the auxiliary voltage exceeds the upper threshold voltage, extending the zero-voltage switching period; when the auxiliary voltage does not exceed the lower threshold voltage, shortening the zero-voltage switching period; and when the auxiliary voltage is between the upper threshold voltage and the lower threshold voltage, maintaining the zero-voltage switching period.

According to an embodiment of the present invention, the control method further comprises: detecting a current flowing through the primary coil and the switching transistor to generate a current detection signal; generating a feedback signal based on the output voltage; and turning on or off the switching transistor based on a relationship between the feedback signal and the current detection signal;

According to an embodiment of the present invention, the control method further comprises: when the feedback signal is lower than a first threshold voltage, extending the predetermined delay period; and when the auxiliary voltage rises to exceed a second threshold voltage, beginning delaying the predetermined delay period.

According to an embodiment of the present invention, the control method further comprises: when the feedback signal is lower than a third threshold voltage, ending the zero-voltage switching period. When output power of the output voltage falls, the feedback signal falls accordingly.

According to an embodiment of the present invention, the control method further comprises: determining whether the auxiliary voltage is in a valley within a delay period after the predetermined delay period; when it is determined that the auxiliary voltage is in the valley, beginning the zero-voltage switching period; and when it is not determined that the auxiliary voltage is in the valley within the delay period, beginning the zero-voltage switching period when the delay period ends.

According to an embodiment of the present invention, the step of determining whether the auxiliary voltage is in the valley within the delay period after the predetermined delay period further comprises: determining whether the auxiliary voltage is lower than a fourth threshold voltage; and when the auxiliary voltage is lower than the fourth threshold, determining the auxiliary voltage is in the valley.

According to an embodiment of the present invention, the other terminal of the auxiliary coil generates a supply voltage. The power conversion circuit further comprises a control circuit, and the control circuit is configured to execute the control method. The supply voltage is configured to power the control circuit. The step of turning off the switching transistor to demagnetize the transformer further comprises: powering the output voltage by the secondary coil; turning on the auxiliary transistor; and when the auxiliary transistor is turned on, powering the supply voltage by the auxiliary coil. The supply voltage is the output voltage multiplied by a turns ratio. The turns ratio is a number of tuns of the auxiliary coil divided by a number of turns of the secondary coil.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a circuit diagram of a power conversion circuit in accordance with an embodiment of the present invention;

FIG. 2 shows a circuit diagram of a zero-voltage switching circuit in accordance with an embodiment of the present invention;

FIG. 3 shows a circuit diagram of a first signal generation circuit in accordance with an embodiment of the present invention;

FIG. 4 shows a circuit diagram of a second signal generation circuit in accordance with an embodiment of the present invention;

FIG. 5 shows a circuit diagram of a third signal generation circuit in accordance with an embodiment of the present invention;

FIG. 6 shows a circuit diagram of a fourth signal generation circuit in accordance with an embodiment of the present invention;

FIG. 7 shows a waveform diagram of a power conversion circuit in accordance with an embodiment of the present invention; and

FIG. 8 shows a flowchart of a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

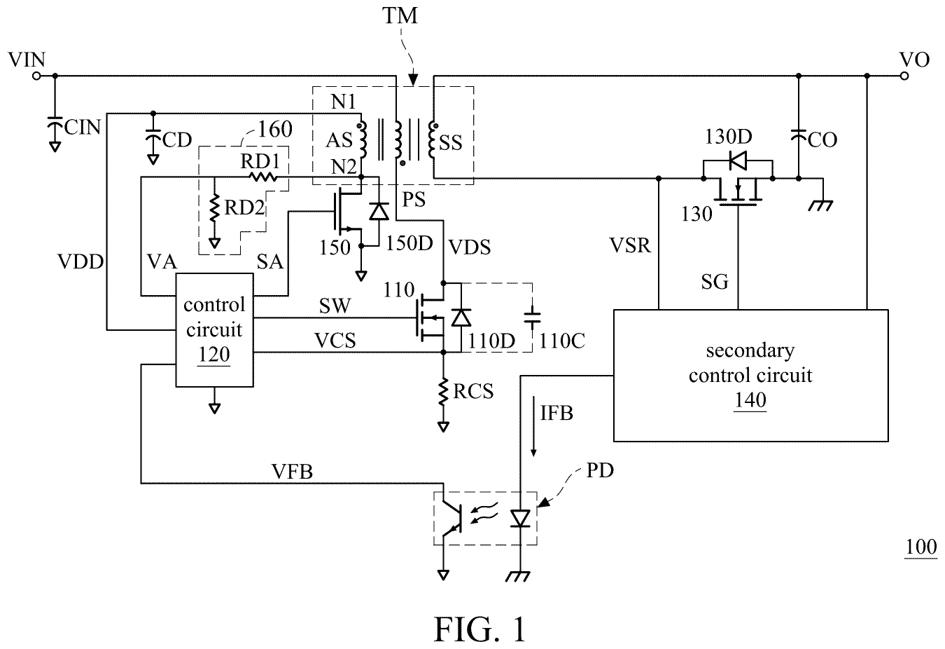

FIG. 1 shows a circuit diagram of a power conversion circuit in accordance with an embodiment of the present invention. As shown in FIG. 1, the power conversion circuit 100 includes an input capacitor CIN, a transformer TM, a switching transistor 110, a current detection resistor RCS, a control circuit 120, a rectification transistor 130, an output capacitor CO, a secondary control circuit 140, and an optocoupler PD. The input capacitor CIN is coupled between the input voltage VIN and ground. The transformer TM includes a primary coil PS, a secondary coil SS, and an auxiliary coil AS, where the primary coil PS is coupled to the input voltage VIN. According to an embodiment of the present invention, the power conversion circuit 100 is a flyback power conversion circuit.

The switching transistor 110 includes a first parasitic diode 110D and a parasitic capacitor 110C, where the first parasitic diode 110D and the parasitic capacitor 110C are respectively coupled between the drain terminal and the source terminal of the switching transistor 110. The gate terminal of the switching transistor 110 receives a switching signal SW, and the drain terminal of the switching transistor 110 is coupled to the primary coil PS, and a drain voltage VDS is generated at the drain terminal of the switching transistor 110. A current detection resistor RCS is coupled between the source terminal and the ground terminal of the switching transistor 110. According to an embodiment of the present invention, when the switching transistor 110 is turned on, a current from the input voltage VIN through the primary coil PS and the switching transistor 110 flows through the current detection resistor RCS to generate a current detection voltage VCS.

The control circuit 120 generates the switching signal SW based on the current detection voltage VCS and the feedback signal VFB. According to some embodiments of the present invention, the switching signal SW turns the switching transistor 110 on or off, causing the switching transistor 110 to achieve zero-voltage switching (ZVS). The rectification transistor 130 includes a second parasitic diode 130D, where the rectification transistor 130 is coupled between a terminal of the secondary coil SS and a ground. The output capacitor CO is coupled between the other terminal of the secondary coil SS and a ground terminal. The secondary control circuit 140 generates a gate signal SG based on the output voltage VO and the synchronization voltage VSR, to turn the rectification transistor 130 on or off.

According to an embodiment of the present invention, when the switching transistor 110 is turned on and magnetizes the primary coil PS, the rectification transistor 130 is turned off. According to another embodiment of the present invention, when the switching transistor 110 is turned off and demagnetizes the primary coil PS, the rectification transistor 130 is turned on. In other words, the conduction time of the rectification transistor 130 is essentially out of phase with the conduction time of the switching transistor 110. Furthermore, the secondary control circuit 140 generates a feedback current IFB based on the output voltage VO. The optocoupler PD generates a feedback signal VFB based on the feedback current IFB.

As shown in FIG. 1, the power conversion circuit 100 further includes an auxiliary capacitor CD, an auxiliary transistor 150, and a voltage-dividing circuit 160. The auxiliary coil AS includes a first node N1 and a second node N2, where the auxiliary capacitor CD is coupled between the first node N1 and ground, and generates a supply voltage VDD at the first node N1. According to some embodiments of the invention, the control circuit 120 is powered by the supply voltage VDD.

The auxiliary transistor 150 includes a third parasitic diode 150D, where the third parasitic diode 150D is coupled between the drain terminal and source terminal of the auxiliary transistor 150. The auxiliary transistor 150 couples the second node N2 to the ground based on the auxiliary control signal SA. The voltage-dividing circuit 160 includes a first voltage-dividing resistor RD1 and a second voltage-dividing resistor RD2, where voltage-dividing circuit 160 is used to divide the voltage of the second node N2 to generate an auxiliary voltage VA.

According to an embodiment of the present invention, when switching transistor 110 is turned on, the input voltage VIN magnetizes the primary coil PS (or, transformer TM), and rectification transistor 130 is turned off. According to another embodiment of the present invention, when switching transistor 110 is turned off, the primary coil PS (or, transformer TM) is demagnetized, energy is transferred to the secondary coil SS, the rectification transistor 130 is turned on to charge the output capacitor CO with the current output from the secondary coil SS, thereby generating an output voltage VO. According to some embodiments of the present invention, when transformer TM is demagnetized, auxiliary transistor 150 is turned on, causing auxiliary coil AS to charge auxiliary capacitor CD, thereby generating a supply voltage VDD.

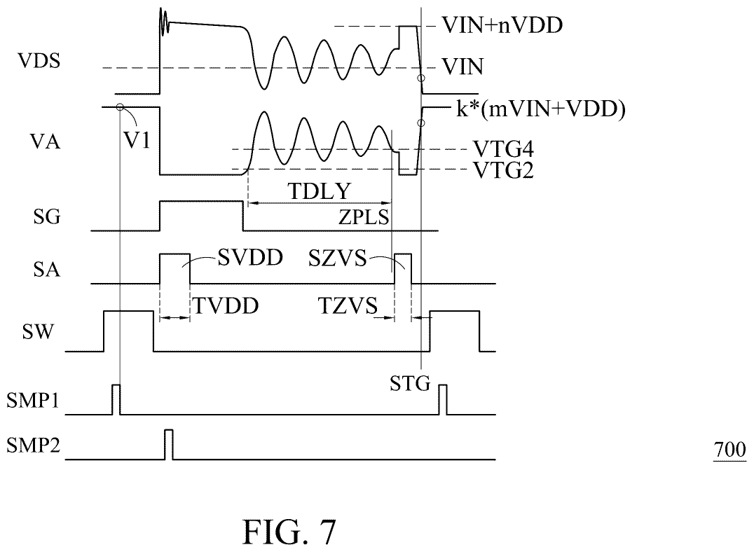

According to some embodiments of the present invention, after the primary coil PS has finished demagnetization and after a predetermined delay period TDLY (as shown in FIG. 7) is passed, the auxiliary control signal SA turns on the auxiliary transistor 150, causing the primary coil PS to generate a current flowing from the drain voltage VDS to the input voltage VIN, thereby discharging the parasitic capacitor 110C and reducing the drain voltage VDS when the switching transistor 110 is turned on. In other words, a circulating current can be generated in the primary coil PS by turning on the auxiliary transistor 150, thereby reducing the drain voltage VDS when the switching transistor 110 is turned on.

When the switching transistor 110 turns on after the auxiliary transistor 150 has turned off, the switching transistor 110 is controlled to turn on when the drain voltage VDS is equal to zero, so that the switching transistor 110 can achieve zero-voltage switching. According to some embodiments of the present invention, the predetermined delay period TDLY increases as the feedback signal VFB decreases to adapt to different load states. According to some embodiments of the present invention, when the feedback signal VFB is less than a threshold, it indicates that the power conversion circuit 100 is in a light load state. According to some embodiments of the present invention, since the predetermined delay period TDLY increases as the load decreases, it indicates that the power conversion circuit 100 reduces its frequency as the load decreases.

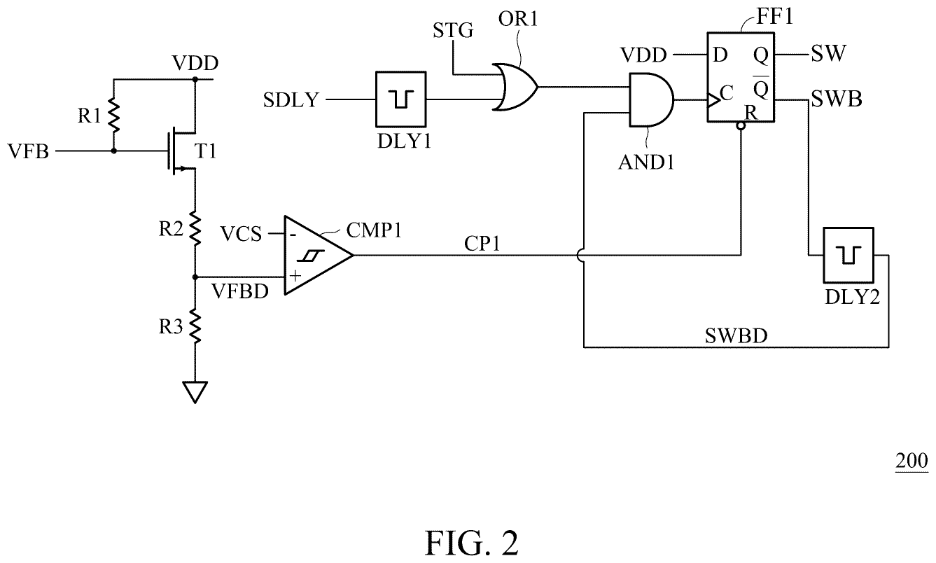

FIG. 2 shows a circuit diagram of a zero-voltage switching circuit in accordance with an embodiment of the present invention. According to some embodiments of the present invention, the control circuit 120 of FIG. 1 includes a zero-voltage switching circuit 200. As shown in FIG. 2, the zero-voltage switching circuit 200 includes a first transistor T1, a first resistor R1, a second resistor R2, a third resistor R3, and a first comparator CMP1.

The drain terminal of the first transistor T1 is coupled to the supply voltage VDD of the first node N1 in FIG. 1. A first resistor R1 is coupled between the drain terminal and the gate terminal of the first transistor T1. A second resistor R2 and a third resistor R3 are connected in series between the source terminal of the first transistor T1 and the ground, and a voltage-dividing feedback signal VFBD is generated between the second resistor R2 and the third resistor R3. The first comparator CMP1 compares the voltage-dividing feedback signal VFBD with the current detection voltage VCS in FIG. 1 to generate a first comparison signal CP1.

As shown in FIG. 2, the zero-voltage switching circuit 200 further includes a first OR gate OR1, a first AND gate AND1, a first flip-flop FF1, a first delay circuit DLY1, and a second delay circuit DLY2. As described above, after the primary coil PS demagnetizes and a predetermined delay period TDLY is passed, the trigger signal STG is enabled to control the first flip-flop FF1, via the first OR gate OR1 and the first AND gate AND1, to output the supply voltage VDD as a switching signal SW (i.e., enable switching signal SW), thereby turning on the switching transistor 110 in FIG. 1.

When the trigger signal STG is not enabled, the delay period signal SDLY controls the first flip-flop FF1 to enable the switching signal SW via the first OR gate OR1 and the first AND gate AND1 after being delayed for a first delay period via the first delay circuit DLY1. According to an embodiment of the present invention, when the switching signal SW is enabled and the current detection voltage VCS exceeds the voltage-dividing feedback signal VFBD, the first comparison signal CP1 resets the first flip-flop FF1 and disables the switching signal SW, thereby turning off the switching transistor 110 in FIG. 1. According to some embodiments of the present invention, the trigger signal STG and the delay period signal SDLY will be described in detail in the following paragraphs.

When the switching signal SW is disabled, the enabled inverted switching signal SWB is delayed by a second delay period via the second delay circuit DLY2 to generate a delayed inverted switching signal SWBD provided to the first gate AND1. According to some embodiments of the present invention, the first delay circuit DLY1 and the second delay circuit DLY2 are pulse generation circuits, where the first delay period and the second delay period are respectively the pulse widths of the pulse generation circuit.

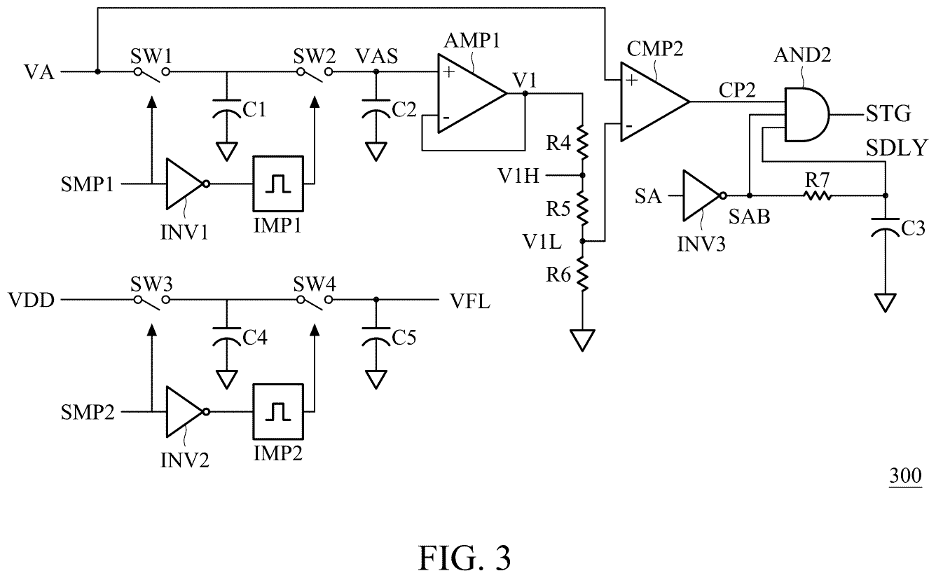

FIG. 3 shows a circuit diagram of a first signal generation circuit in accordance with an embodiment of the present invention. According to some embodiments of the present invention, the control circuit 120 of FIG. 1 includes a first signal generation circuit 300. As shown in FIG. 3, the first signal generation circuit 300 includes a first switch SW1, a first capacitor C1, a first inverter INV1, a first pulse generation circuit IMP1, a second switch SW2, a second capacitor C2, a first amplifier AMP1, a fourth resistor R4, a fifth resistor R5, a sixth resistor R6, a second comparator CMP2, a third inverter INV3, a seventh resistor R7, a third capacitor C3, and a second gate AND2.

According to an embodiment of the present invention, when the first sampling signal SMP1 is enabled, the first switch SW1 is turned on to provide an auxiliary voltage VA to the first capacitor C1 for storage. According to another embodiment of the present invention, when the first sampling signal SMP1 is disabled, the first inverter INV1 inverts the first sampling signal SMP1, triggering the first pulse generation circuit IMP1 to turn on the second switch SW2, so that the voltage stored in the first capacitor C1 charges the second capacitor C2, thereby generating a sampling auxiliary voltage VAS.

The first amplifier AMP1 is coupled as a unity-gain amplifier to generate a first voltage V1. The fourth resistor R4, the fifth resistor R5, and the sixth resistor R6 are used to divide the first voltage V1 to generate a lower threshold voltage V1L and an upper threshold voltage V1H. In other words, the first switch SW1, the first capacitor C1, the first inverter INV1, the first pulse generation circuit IMP1, the second switch SW2, and the second capacitor C2 form a sample-and-hold circuit, and the sampling auxiliary voltage VAS is equal to the first voltage V1.

The second comparator CMP2 compares the auxiliary voltage VA with the lower threshold voltage V1L to generate a second comparison signal CP2. According to some embodiments of the present invention, when the auxiliary voltage VA exceeds the lower threshold voltage V1L, the second comparator CMP2 enables the second comparison signal CP2. According to some embodiments of the present invention, when the auxiliary voltage VA exceeds the lower threshold voltage V1L, the parasitic capacitor 110C of the switching transistor 110 is discharged to near the ground level by the current flowing from the self-drain voltage VDS through the primary coil PS to the input voltage VIN.

The third inverter INV3 inverts the auxiliary control signal SA to generate an inverted auxiliary control signal SAB. The inverted auxiliary control signal SAB charges the third capacitor C3 via the seventh resistor R7, generating a delay period signal SDLY. According to some embodiments of the present invention, the seventh resistor R7 and the third capacitor C3 are used to determine the third delay period. The second gate AND2 performs a logical AND operation on the second comparison signal CP2, the inverted auxiliary control signal SAB, and the delay period signal SDLY to generate a trigger signal STG.

In other words, when the auxiliary voltage VA exceeds the lower threshold voltage V1L and the auxiliary control signal SA is disabled (i.e., the auxiliary transistor 150 in FIG. 1 is turned off), the second gate AND2 enables the trigger signal STG after the third delay period, where the third delay period is determined by the seventh resistor R7 and the third capacitor C3. According to some embodiments of the present invention, when the auxiliary voltage VA exceeds the lower threshold voltage V1L, causing the trigger signal STG to be enabled, it means that the auxiliary voltage VA after the auxiliary transistor 150 is turned off is close to the auxiliary voltage VA when the switching transistor 110 is turned on.

As shown in FIG. 3, the first signal generation circuit 300 further includes a third switch SW3, a fourth capacitor C4, a second inverter INV2, a second pulse generation circuit IMP2, a fourth switch SW4, and a fifth capacitor C5. The third switch SW3, the fourth capacitor C4, the second inverter INV2, the second pulse generation circuit IMP2, the fourth switch SW4, and the fifth capacitor C5 form another sample-and-hold circuit to sample the supply voltage VDD of FIG. 1 based on the second sampling signal SMP2, thereby generating a reflected voltage VFL.

According to some embodiments of the present invention, the reflected voltage VFL is the output voltage VO multiplied by the turns ratio of the auxiliary coil AS and the secondary coil SS. In other words, the reflected voltage VFL can be used to represent the state of the output voltage VO, and protection functions are implemented using the reflected voltage VFL, including over-voltage protection, under-voltage protection, and/or short-circuit protection.

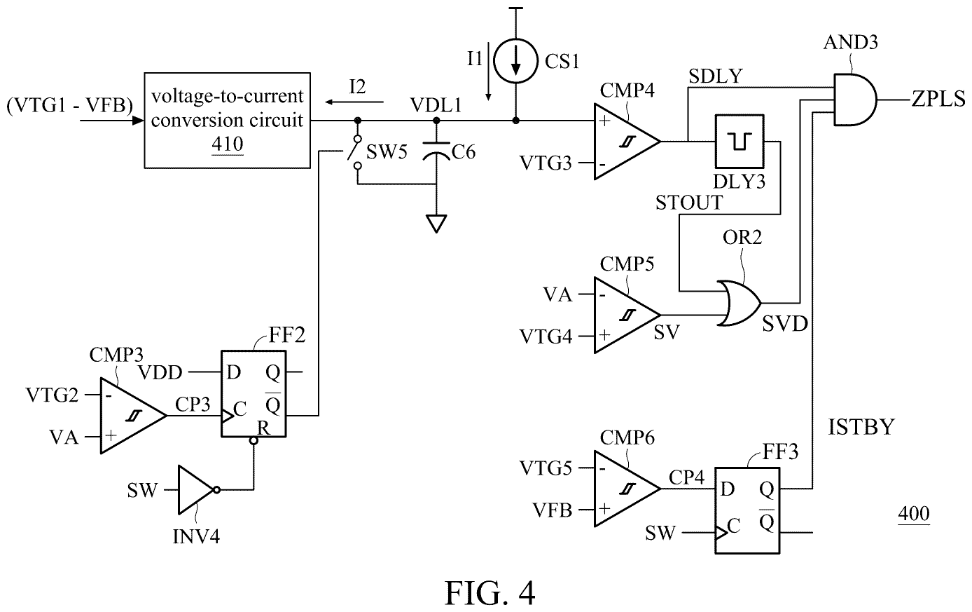

FIG. 4 shows a circuit diagram of a second signal generation circuit in accordance with an embodiment of the present invention. According to some embodiments of the present invention, the control circuit 120 of FIG. 1 includes a second signal generation circuit 400. As shown in FIG. 4, the second signal generation circuit 400 includes a first current source CS1, a sixth capacitor C6, a voltage-to-current conversion circuit 410, a third comparator CMP3, a second flip-flop FF2, a fourth inverter INV4, a fifth switch SW5, and a fourth comparator CMP4.

The first current source CS1 generates a first current I1 to charge the sixth capacitor C6, generating a first delayed voltage VDL1. The voltage-to-current conversion circuit 410 draws a second current I2 from the first delayed voltage VDL1 and determines the value of the second current I2 based on the first threshold voltage VTG1 minus the voltage value of the feedback signal VFB. In other words, the first current I1 minus the second current I2 is configured to charge the sixth capacitor C6.

According to some embodiments of the present invention, when the feedback signal VFB decreases and falls below the first threshold voltage VTG1, the second current I2 increases accordingly. According to some embodiments of the present invention, when the output power of the output voltage VO decreases, the feedback signal VFB decreases and the second current I2 increases. In other words, when the feedback signal VFB decreases and falls below the first threshold voltage VTG1, the charging current for the sixth capacitor C6 decreases accordingly.

The third comparator CMP3 compares the auxiliary voltage VA and the second threshold voltage VTG2 to generate a third comparison signal CP3. When the auxiliary voltage VA rises to exceed the second threshold voltage VTG2, the third comparator CMP3 generates a rising edge on the third comparison signal CP3, triggering the second flip-flop FF2 to provide an inverse of the supply voltage VDD to the fifth switch SW5, thereby turning off the fifth switch SW5 and starting to charge the sixth capacitor C6.

The fourth comparator CMP4 compares the first delay voltage VDL1 and the third threshold voltage VTG3 to generate a delay period signal SDLY. According to some embodiments of the present invention, when the first delay voltage VDL1 exceeds the third threshold voltage VTG3, the fourth comparator CMP4 enables the delay period signal SDLY. According to some embodiments of the present invention, the first current I1, the second current I2, the sixth capacitor C6, and the third threshold voltage VTG3 are used to determine the predetermined delay period TDLY.

According to some embodiments of the present invention, when the output power of the output voltage VO decreases, the second current I2 increases, thereby extending the predetermined delay period TDLY. According to other embodiments of the present invention, when the output power of the output voltage VO increases, the second current I2 decreases, thereby shortening the predetermined delay period TDLY.

As shown in FIG. 4, the second signal generation circuit 400 further includes a third delay circuit DLY3, a fifth comparator CMP5, a second OR gate OR2, a sixth comparator CMP6, a third flip-flop FF3, and a third AND gate AND3. When the delay period signal SDLY is enabled, the third delay circuit DLY3 enables the pause signal STOUT after a fourth delay period. The fifth comparator CMP5 compares the auxiliary voltage VA and the fourth threshold voltage VTG4 to generate a valley signal SV. The second OR gate OR2 performs a logical OR operation on the pause signal STOUT and the valley signal SV to generate a valley detection signal SVD.

The sixth comparator CMP6 compares the feedback signal VFB and the fifth threshold voltage VTG5 to generate a fourth comparison signal CP4. According to an embodiment of the present invention, when the feedback signal VFB exceeds the fifth threshold voltage VTG5, the sixth comparator CMP6 enables the fourth comparison signal CP4. According to another embodiment of the present invention, when the feedback signal VFB does not exceed the fifth threshold voltage VTG5, the sixth comparator CMP6 disables the fourth comparison signal CP4. The third flip-flop FF3 outputs the fourth comparison signal CP4 as a standby signal ISTBY based on the rising edge of the switching signal SW.

The third AND gate AND3 performs a logical AND operation on the delay period signal SDLY, the valley detection signal SVD, and the standby signal ISTBY to generate a start pulse signal ZPLS. In other words, when the primary coil PS (or transformer TM) in FIG. 1 finishes demagnetization, and the auxiliary voltage VA rises to exceed the second threshold voltage VTG2, the fifth switch SW5 is turned off, and the sixth capacitor C6 begins charging to count the predetermined delay period TDLY.

When the predetermined delay period TDLY determined by the first current I1, the second current I2, the sixth capacitor C6, and the third threshold voltage VTG3 is reached, the delay period signal SDLY is enabled, and it is determined whether the auxiliary voltage VA has reached its valley (i.e., the valley signal SV), where the auxiliary voltage VA is related to the supply voltage VDD. When the auxiliary voltage VA is detected to have reached its valley, or when the auxiliary voltage VA is not detected to have reached its valley within the fourth delay period delayed by the third delay circuit DLY3, the second signal generation circuit 400 enables the start pulse signal ZPLS.

Furthermore, when the feedback signal VFB is lower than the fifth threshold voltage VTG5, the sixth comparator CMP6 and the third flip-flop FF3 disable the standby signal ISTBY, causing the start pulse signal ZPLS to be unable to be enabled. According to some embodiments of the present invention, since the feedback signal VFB being too low indicates that output power of the output voltage VO is too low, the start pulse signal ZPLS being disabled can eliminate power loss caused by the circulating current of the primary coil PS, thereby improving the switching efficiency under light load conditions.

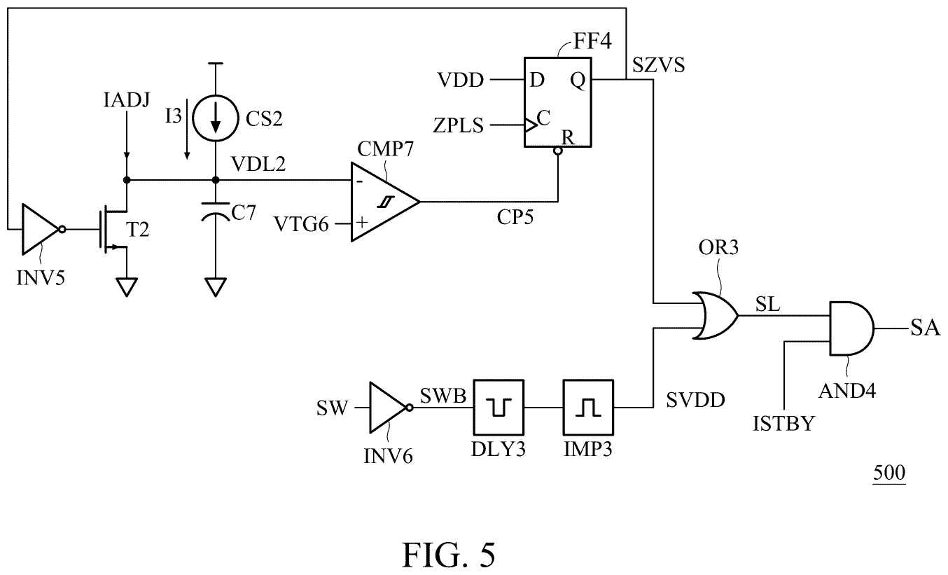

FIG. 5 shows a circuit diagram of a third signal generation circuit in accordance with an embodiment of the present invention. According to some embodiments of the present invention, the control circuit 120 of FIG. 1 includes a third signal generation circuit 500. As shown in FIG. 5, the third signal generation circuit 500 includes a fourth flip-flop FF4, a fifth inverter INV5, a second transistor T2, a second current source CS2, a seventh capacitor C7, a seventh comparator CMP7, a sixth inverter INV6, a third delay circuit DLY3, a third pulse generation circuit IMP3, a third OR gate OR3, and a fourth AND gate AND4.

When the second signal generation circuit 400 enables the start pulse signal ZPLS, the rising edge of the start pulse signal ZPLS triggers the fourth flip-flop FF4 to enable the zero-voltage switching signal SZVS. The enabled zero-voltage switching signal SZVS turns off the second transistor T2 via the fifth inverter INV5, causing the sum of the third current I3 generated by the second current source CS2 and the adjustment current IADJ to charge the seventh capacitor C7, thereby generating the second delay voltage VDL2.

When the second delay voltage VDL2 exceeds the sixth threshold voltage VTG6, the seventh comparator CMP7 disables the fifth comparison signal CP5 and resets the fourth flip-flop FF4, thereby disabling the zero-voltage switching signal SZVS. In other words, the sum of the third current I3 and the adjustment current IADJ, the seventh capacitor C7, and the delay period determined by the sixth threshold voltage VTG6 determine the length of the zero-voltage switching period TZVS of the zero-voltage switching signal SZVS.

When the switching signal SW is disabled and the switching transistor 110 is off, the primary coil PS (or, transformer TM) begins to demagnetize. The inverted switching signal SWB enabled by the sixth inverter INV6 enables the third pulse generation circuit IMP3 to generate the supply voltage pulse signal SVDD after a delay period generated by the third delay circuit DLY3.

The third OR gate OR3 performs a logical OR operation on the zero-voltage switching signal SZVS and the supply voltage pulse signal SVDD to generate the logic signal SL. The fourth gate AND4 performs a logical AND operation on the logic signal SL and the standby signal ISTBY to generate an auxiliary control signal SA. In other words, when the output power of the output voltage VO is too low, causing the standby signal ISTBY to be disabled, the disabled auxiliary control signal SA does not generate a circulating current in the primary coil PS to discharge the parasitic capacitor 110C, thereby improving the conversion efficiency under light loads.

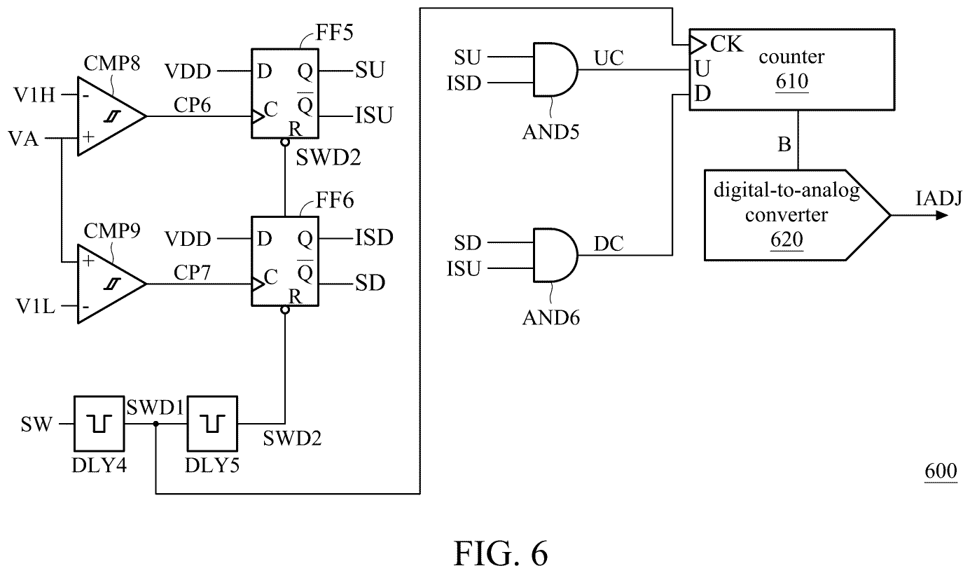

FIG. 6 shows a circuit diagram of a fourth signal generation circuit in accordance with an embodiment of the present invention. According to some embodiments of the present invention, the control circuit 120 of FIG. 1 includes a fourth signal generation circuit 600. As shown in FIG. 6, the fourth signal generation circuit 600 includes an eighth comparator CMP8, a fifth flip-flop FF5, a ninth comparator CMP9, a sixth flip-flop FF6, a fifth gate AND5, a sixth gate AND6, a fourth delay circuit DLY4, a fifth delay circuit DLY5, a counter 610, and a digital-to-analog converter 620.

The eighth comparator CMP8 compares the auxiliary voltage VA with the upper threshold voltage V1H generated by the first signal generation circuit 300 in FIG. 3, generating a sixth comparison signal CP6. When the auxiliary voltage VA rises to exceed the upper threshold voltage V1H, the rising edge of the sixth comparison signal CP6 triggers the fifth flip-flop FF5 to enable the up-counting signal SU and disable the inverted up-counting signal ISU.

The ninth comparator CMP9 compares the lower threshold voltage V1L generated by the first signal generation circuit 300 in FIG. 3 with the auxiliary voltage VA, generating a seventh comparison signal CP7. When the auxiliary voltage VA rises to exceed the lower threshold voltage V1L, the rising edge of the seventh comparison signal CP7 triggers the sixth flip-flop FF6 to enable the inverted down-counting signal ISD and disable the down-counting signal SD.

The fifth AND gate AND5 performs a logical AND operation on the up-counting signal SU and the inverted down-counting signal ISD to generate a up-count signal UC. The sixth gate AND6 performs a logical AND operation on the down-counting signal SD and the inverted up-counting signal ISU to generate the down-count signal DC. The fourth delay circuit DLY4 generates a negative pulse on the first delayed switching signal SWD1 based on the rising edge of the switching signal SW.

The fifth delay circuit DLY5 generates a negative pulse on the second delayed switching signal SWD2 based on the rising edge of the first delayed switching signal SWD1. The negative pulse of the second delayed switching signal SWD2 is configured to reset the fifth flip-flop FF5 and the sixth flip-flop FF6. The counter 610 uses the first delayed switching signal SWD1 as the clock signal to increase or decrease the count value according to the up-count signal UC and the down-count signal DC to generate the digital code B.

As shown in FIG. 6, when the fifth delay circuit DLY5 resets the fifth flip-flop FF5 and the sixth flip-flop FF6, the fifth flip-flop FF5 disables the up-count signal SU, and the sixth flip-flop FF6 enables the down-count signal SD. In other words, after the rising edge of the switching signal SW, it is assumed that the counter 610 decreases the count value (i.e., counting downward). When the auxiliary voltage VA rises to between or even exceed the upper threshold voltage V1H, the counter 610 maintains the count value or increases the count value (i.e., counting upward) respectively.

According to an embodiment of the present invention, when it is determined that the up-count signal UC is enabled and the down-count signal DC is disabled, the counter 610 increases the 1 count value. According to another embodiment of the present invention, when it is determined that the up-count signal UC is disabled and the down-count signal DC is enabled, the counter 610 decreases the count value. Subsequently, the digital-to-analog converter 620 generates an adjustment current IADJ based on the digital code B generated by the counter 610. In other words, when the auxiliary voltage VA exceeds the upper threshold voltage V1H, the adjustment current IADJ increases; when the auxiliary voltage VA does not exceed the lower threshold voltage V1L, the adjustment current IADJ decreases.

According to an embodiment of the present invention, when the adjustment current IADJ increases, the zero-voltage switching period TZVS of the zero-voltage switching signal SZVS generated by the third signal generation circuit 500 is shortened accordingly, thereby reducing the circulating current discharging the parasitic capacitor 110C in FIG. 1. According to another embodiment of the present invention, when the adjustment current IADJ decreases, the zero-voltage switching period TZVS of the zero-voltage switching signal SZVS generated by the third signal generation circuit 500 is extended accordingly, thereby increasing the circulating current discharging the parasitic capacitor 110C in FIG. 1. In other words, the fourth signal generation circuit 600 automatically adjusts the enable time of the zero-voltage switching signal SZVS based on the voltage value of the auxiliary voltage VA, thereby generating the optimal circulating current and achieving the optimal power conversion efficiency.

According to some embodiments of the present invention, when the switching signal SW transitions from a disabled state to an enabled state to begin a new driving cycle, the fourth signal generation circuit 600 generates a corresponding adjustment current IADJ based on the state of the auxiliary voltage VA of the previous driving cycle, thereby determining the length of the zero-voltage switching period TZVS of the current driving cycle.

FIG. 7 shows a waveform diagram of a power conversion circuit in accordance with an embodiment of the present invention. The following description of waveform 700 will be provided in conjunction with the power conversion circuit 100 in FIG. 1, the zero-voltage switching circuit 200 in FIG. 2, the first signal generation circuit 300 in FIG. 3, the second signal generation circuit 400 in FIG. 4, the third signal generation circuit 500 in FIG. 5, and the fourth signal generation circuit 600 in FIG. 6 for detailed explanation.

As shown in FIG. 7, when the switching signal SW is enabled to turn on the switching transistor 110, the primary coil PS (or transformer TM) is magnetized, and the first sampling signal SMP1 is enabled to sample the auxiliary voltage VA. The sampled first voltage V1 is as shown in Eq. 1, where m is the number of turns of the auxiliary coil AS divided by the number of turns of the primary coil PS, and k is the voltage division ratio generated by the voltage-dividing circuit 160.

$$V 1 = k \times ( m \times VIN + VDD ) \qquad ( Eq . 1 )$$

According to some embodiments of the present invention, as shown in FIG. 3, the first signal generation circuit 300 generates samples the auxiliary voltage VA based on a first sampling signal SMP1 to generate the first voltage V1. Returning to FIG. 7, the auxiliary control signal SA includes a supply voltage pulse signal SVDD, and the supply voltage pulse signal SVDD has a pulse enable time TVDD. When the switching signal SW turns off the switching transistor 110 and a delay period is passed, the enabled supply voltage pulse signal SVDD turns on the auxiliary transistor 150 to generate the supply voltage VDD. According to some embodiments of the present invention, the supply voltage VDD is proportional to the output voltage VO.

According to some embodiments of the present invention, as shown in FIG. 5, the pulse enable time TVDD is determined by the third pulse generation circuit IMP3. Furthermore, the delay period from the switching signal SW turning off the switching transistor 110 to the supply voltage pulse signal SVDD being enabled is determined by the third delay circuit DLY3.

As shown in FIG. 7, when the gate signal SG is enabled, the transformer TM demagnetizes. When the supply voltage pulse signal SVDD is subsequently enabled, the second sampling signal SMP2 is enabled. The first signal generation circuit 300 in FIG. 3 samples the supply voltage VDD based on the second sampling signal SMP2 to generate a reflected voltage VFL. The reflected voltage VFL is as shown in Eq. 2, where x is the number of turns of the auxiliary coil AS divided by the number of turns of the secondary coil SS. In other words, the reflected voltage VFL can be used to represent the voltage state of the output voltage VO.

$$VFL = x \times VO \qquad ( Eq . 2 )$$

As shown in FIG. 7, when the gate signal SG is disabled, the transformer TM ends demagnetization, and the auxiliary voltage VA rises and begins to oscillate. When the auxiliary voltage VA exceeds the second threshold voltage VTG2 and a predetermined delay period TDLY is passed, it is determined whether the auxiliary voltage VA is at a valley so as to enable the zero-voltage switching signal SZVS.

According to some embodiments of the present invention, as shown in FIG. 4, when the auxiliary voltage VA exceeds the second threshold voltage VTG2, the fifth switch SW5 is turned off and the sixth capacitor C6 begins being charged, thereby generating a predetermined delay period TDLY. When the fifth comparator CMP5 determines that the auxiliary voltage VA is lower than the fourth threshold voltage VTG4 or that the auxiliary voltage VA is not lower than the fourth threshold voltage VTG4 within the delay period generated by the third delay circuit DLY3, the start pulse signal ZPLS is enabled.

As shown in FIG. 5, the enabled start pulse signal ZPLS enables the zero-voltage switching signal SZVS. The zero-voltage switching period TZVS of the zero-voltage switching signal SZVS in FIG. 7 is determined by the third current I3, the adjustment current IADJ, the seventh capacitor C7, and the sixth threshold voltage VTG6. As shown in FIG. 7, when the zero-voltage switching signal SZVS is enabled, the auxiliary voltage VA is zero, and the drain voltage VDS is as shown in Eq. 3, where n is the number of turns of the primary coil PS divided by the number of turns of the auxiliary coil AS.

$$VDS = VIN + n \times VDD \qquad ( Eq . 3 )$$

According to some embodiments of the present invention, after the zero-voltage switching period TZVS in FIG. 7, the fourth signal generation circuit 600 adjusts the adjustment current IADJ based on the voltage value of the auxiliary voltage VA, thereby adjusting the zero-voltage switching period TZVS of next cycle. Specifically, when the auxiliary voltage VA does not exceed the lower threshold voltage V1L, the adjustment current IADJ is reduced, thus extending the length of the zero-voltage switching period TZVS. When the auxiliary voltage VA rises to between the lower threshold voltage V1L and the upper threshold voltage V1H, the adjustment current IADJ is maintained, thus maintaining the length of the zero-voltage switching period TZVS. When the auxiliary voltage VA exceeds the upper threshold voltage V1H, the adjustment current IADJ is increased, thus shortening the length of the zero-voltage switching period TZVS.

Furthermore, after the zero-voltage switching signal SZVS is disabled, the control circuit 120 monitors the auxiliary voltage VA to generate a trigger signal STG. As shown in FIG. 3, when the zero-voltage switching signal SZVS is disabled (equivalent to the auxiliary control signal SA being disabled) and the auxiliary voltage VA exceeds the lower threshold voltage V1L, the trigger signal STG is enabled after a delay period determined by the seventh resistor R7 and the third capacitor C3. As shown in FIG. 2, the rising edge generated by the enabled trigger signal STG triggers the first flip-flop FF1 to enable the switching signal SW.

In other words, when the zero-voltage switching signal SZVS is disabled and a delay period determined by the seventh resistor R7 and the third capacitor C3 is passed, it is determined whether the auxiliary voltage VA is close to the auxiliary voltage VA when the switching transistor 110 is turned on. In the embodiment of FIG. 7, when the switching signal SW is enabled, the auxiliary voltage VA is the first voltage V1. In the embodiment of FIG. 3, when it is determined that the auxiliary voltage VA exceeds the lower threshold value V1L, it means that the zero-voltage switching signal SZVS is disabled and the auxiliary voltage VA after the delay period is close to the auxiliary voltage VA when the switching transistor 110 is turned on.

In the embodiment of FIG. 6, since the lower number signal SD is enabled when the sixth flip-flop FF6 is reset, the fourth signal generator 600 pre-decreases the adjustment current IADJ to extend the length of the zero-voltage switching period TZVS. In other words, since the auxiliary voltage VA increases from zero after the zero-voltage switching signal SZVS is disabled, when the zero-voltage switching signal SZVS is disabled and the auxiliary voltage VA does not exceed the lower threshold voltage V1L after a delay period is passed, the fourth signal generator 600 reduces the adjustment current IADJ, thereby extending the length of the zero-voltage switching period TZVS.

When it is determined that the auxiliary voltage VA rises to between the upper threshold voltage V1H and the lower threshold voltage V1L (that is, when it is determined that the auxiliary voltage VA after the zero-voltage switching signal SZVS is disabled and a delay period is passed is close to the auxiliary voltage VA when the switching transistor 110 is turned on), the third signal generator 600 maintains the adjustment current IADJ, thereby maintaining the length of the zero-voltage switching period TZVS. When the auxiliary voltage VA exceeds the upper threshold voltage V1H, the third signal generator 600 increases the adjustment current IADJ, thereby shortening the length of the zero-voltage switching period TZVS.

According to some embodiments of the present invention, after the zero-voltage switching period TZVS ends, the control circuit 120 monitors whether the voltage level of the auxiliary voltage VA is close to the voltage level of the auxiliary voltage VA when the switching transistor 110 is turned on, so as to determine the timing of enabling the switching signal SW. As shown in FIG. 7, after the zero-voltage switching period TZVS ends, a higher auxiliary voltage VA represents a lower drain voltage VDS. In other words, by monitoring the voltage level of the auxiliary voltage VA, it can be determined whether the drain voltage VDS is low enough to enable the switching transistor 110 to achieve zero-voltage switching.

Therefore, when it is determined that the auxiliary voltage VA is high enough (i.e., the auxiliary voltage VA exceeds the lower threshold voltage V1L) and after a third delay period determined by the seventh resistor R7 and the third capacitor C3 of the first signal generation circuit 300, the trigger signal STG is enabled. Furthermore, after the delay period of the first OR gate OR1, the first AND gate AND1, and the first flip-flop FF1 in FIG. 2, the enable switching signal SW is enabled to turn on the switching transistor 110.

According to some embodiments of the present invention, when the voltage level of the auxiliary voltage VA at the end of the zero-voltage switching period TZVS differs significantly from the voltage level of the auxiliary voltage VA when the switching transistor 110 is turned on, the length of the zero-voltage switching period TZVS is adjusted by adjusting the adjustment current IADJ.

According to some embodiments of the present invention, when the trigger signal STG is not enabled, as shown in FIG. 2, the enabled delay period signal SDLY generates a rising edge after the first delay period delayed by the first delay circuit DLY1, triggering the first flip-flop FF1 to enable the switching signal SW. As shown in FIG. 4, when the predetermined delay period TDLY ends, the fourth comparator CMP4 enables the delay period signal SDLY. In other words, within the first delay period after the predetermined delay period TDLY ends, it is determined whether the trigger signal STG is enabled. When the trigger signal STG is not even enabled after the first delay period, the zero-voltage switching circuit 200 still enables the switching signal SW.

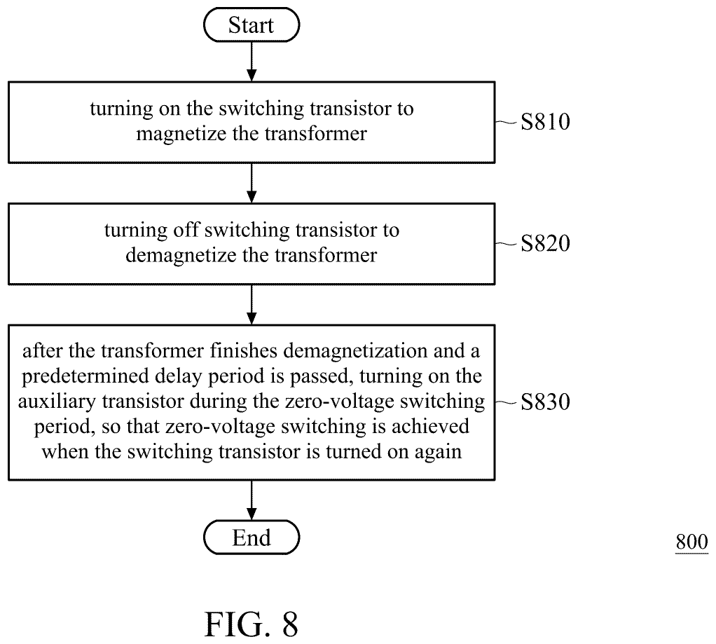

FIG. 8 shows a flowchart of a control method in accordance with an embodiment of the present invention. The following description of the control method 800 will be provided in conjunction with the waveform diagram 700 of FIG. 7 for detailed explanation. First, the switching signal SW is enabled to turn on the switching transistor 110, causing the transformer TM to be magnetized (step S810). In the embodiment of FIG. 7, the transformer TM is magnetized when the switching signal SW is enabled. Next, the switching transistor 110 is turned off, demagnetizing the transformer TM (step S820). In the embodiment of FIG. 7, the transformer TM demagnetizes when the switching signal SW is disabled and the gate signal SG is enabled.

After the transformer TM finishes demagnetization and a predetermined delay period TDLY is passed, the auxiliary transistor 150 is turned on during the zero-voltage switching period TZVS, so that zero-voltage switching is achieved when the switching transistor 110 is turned on again (step S830). According to some embodiments of the present invention, turning on the auxiliary transistor 150 during the zero-voltage switching period TZVS generates a current flowing from the drain voltage VDS to the input voltage VIN in the primary coil PS, thereby discharging the parasitic capacitor 110C. According to some embodiments of the present invention, when the drain voltage VDS drops to near zero, the switching transistor 110 is immediately turned on, so that the switching transistor 110 achieves zero-voltage switching.

According to some embodiments of the present invention, since directly monitoring the drain voltage VDS will inevitably affect the primary coil PS, the present invention determines whether the drain voltage VDS has dropped to near zero by monitoring the auxiliary voltage VA generated by the auxiliary coil AS. As shown in FIG. 7, when the drain voltage VDS drops to zero, the auxiliary voltage VA rises to the first voltage V1. The state of the auxiliary voltage VA is determined by utilizing the upper threshold voltage V1H and lower threshold voltage V1L generated by the first voltage V1, thereby determining the timing for turning on the switching transistor 110.

A zero-voltage switching flyback power conversion circuit and its control method is provided herein. By turning on the auxiliary transistor, a negative current is generated in the primary coil, thereby reducing the drain voltage to zero. Furthermore, this invention further determines the timing for turning on the switching transistor once again by monitoring the voltage level of the auxiliary voltage generated by the auxiliary coil, thus ensuring that zero-voltage switching is achieved when the switching transistor is turned on. Moreover, this invention can adjust the conduction time of the auxiliary transistor by monitoring the voltage level of the auxiliary voltage before the switching transistor is turned on, thereby ensuring that the switching transistor achieves zero-voltage switching.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil, a secondary coil, and an auxiliary coil, wherein the primary coil receives an input voltage, and the secondary coil generates an output voltage;
a switching transistor, coupled between the primary coil and a ground;
an auxiliary transistor, coupled between a terminal of the auxiliary coil and the ground; and
a control circuit, driving the switching transistor based on the output voltage;
wherein when the transformer ends demagnetization and a predetermined delay period is passed, the control circuit turns on the auxiliary transistor in a zero-voltage switching period so that the switching transistor achieves zero-voltage switching when the switching transistor is turned on once again.

2. The power conversion circuit as claimed in claim 1, wherein an auxiliary voltage is generated between the auxiliary coil and the auxiliary transistor;
wherein the control circuit determines whether the auxiliary voltage after the zero-voltage switching period ends and a delay period is passed is close to the auxiliary voltage when the switching transistor is turned on;
wherein when the auxiliary voltage after the zero-voltage switching period ends and the delay period is passed close to the auxiliary voltage when the switching transistor is turned on, the control circuit maintains the length of the zero-voltage switching period;
wherein when the auxiliary voltage after the zero-voltage switching period ends and the delay period is passed is not close to the auxiliary voltage when the switching transistor is turned on, the control circuit adjusts the length of the zero-voltage switching period.

3. The power conversion circuit as claimed in claim 2, wherein when the auxiliary voltage exceeds an upper threshold voltage, the control circuit extends the zero-voltage switching period;
wherein when the auxiliary voltage does not exceed a lower threshold voltage, the control circuit shortens the zero-voltage switching period;
wherein when the auxiliary voltage is between the upper threshold voltage and the lower threshold voltage, the control circuit maintains the zero-voltage switching period.

4. The power conversion circuit as claimed in claim 2, further comprising:
a current detection resistor, coupled between the switching transistor and the ground;
a secondary control circuit, generating a feedback current based on the output voltage; and
an optocoupler, generating a feedback signal based on the feedback current;
wherein a current from the input voltage flowing through the primary coil and the switching transistor flows through the current detection resistor to generate a current detection signal;
wherein the control circuit turns on or off the switching transistor based on a relationship between the feedback signal and the current detection signal.

5. The power conversion circuit as claimed in claim 4, wherein when the feedback signal is lower than a first threshold voltage, the control circuit extends the predetermined delay period.

6. The power conversion circuit as claimed in claim 4, wherein when the auxiliary voltage rises to exceed a second threshold voltage, the control circuit begins delaying the predetermined delay period.

7. The power conversion circuit as claimed in claim 4, wherein when the feedback signal is less than a third threshold voltage, the control circuit ends the zero-voltage switching period;
wherein when output power of the output voltage falls, the feedback signal falls accordingly.

8. The power conversion circuit as claimed in claim 2, wherein the control circuit determines whether the auxiliary voltage is at a valley after the predetermined delay period is passed;
wherein when the control circuit determines that the auxiliary voltage is at the valley, the control circuit begins the zero-voltage switching period;
wherein when the control circuit does not determine that the auxiliary voltage is at the valley in a delay period after the predetermined delay period, the control circuit begins the zero-voltage switching period after the delay period ends.

9. The power conversion circuit as claimed in claim 8, wherein when the auxiliary voltage is less than a fourth threshold voltage, the control circuit determines that the auxiliary voltage is at the valley.

10. The power conversion circuit as claimed in claim 1, wherein the other terminal of the auxiliary coil generates a supply voltage;
wherein the supply voltage is configured to power the control circuit;
wherein when the transformer demagnetizes, the secondary coil powers the output voltage and the control circuit turns on the auxiliary transistor, so that the auxiliary coil powers the supply voltage;
wherein the supply voltage is the output voltage multiplied by a turns ratio;
wherein the turns ratio is a number of turns of the auxiliary coil divided by a number of turns of the secondary coil.

11. The power conversion circuit as claimed in claim 1, wherein the power conversion is a flyback power conversion circuit.

12. A control method for controlling a power conversion circuit, wherein the power conversion circuit comprises a transformer, a switching transistor, and an auxiliary transistor, wherein the transformer comprises a primary coil receiving an input voltage, a secondary coil generating an output voltage, and an auxiliary coil, wherein the switching transistor is coupled between the primary coil and a ground, wherein the auxiliary transistor is coupled between a terminal of the auxiliary coil and the ground, wherein the control method comprises:
turning on the switching transistor to magnetize the transformer;
turning off the switching transistor to demagnetize the transformer; and
after the transformer ends demagnetization and a predetermined delay period is passed, turning on the auxiliary transistor in a zero-voltage switching period so that the switching transistor achieves zero-voltage switching when the switching transistor turns on once again.

13. The control method as claimed in claim 12, wherein an auxiliary voltage is generated between the auxiliary coil and the auxiliary transistor;
wherein the control method further comprises:
determining whether the auxiliary voltage after the zero-voltage switching period ends and a delay period is passed is close to the auxiliary voltage when the switching transistor turns on;
when the auxiliary voltage after the zero-voltage switching period ends and the delay period is passed is close to the auxiliary voltage when the switching transistor turns on, maintaining a length the zero-voltage switching period; and
when the auxiliary voltage after the zero-voltage switching period ends and the delay period is passed is not close to the auxiliary voltage when the switching transistor turns on, adjusting the length of the zero-voltage switching period.

14. The control method as claimed in claim 13, further comprising:
comparing the auxiliary voltage with an upper threshold voltage and a lower threshold voltage;
when the auxiliary voltage exceeds the upper threshold voltage, extending the zero-voltage switching period;
when the auxiliary voltage does not exceed the lower threshold voltage, shortening the zero-voltage switching period; and
when the auxiliary voltage is between the upper threshold voltage and the lower threshold voltage, maintaining the zero-voltage switching period.

15. The control method as claimed in claim 13, further comprising:
detecting a current flowing through the primary coil and the switching transistor to generate a current detection signal;
generating a feedback signal based on the output voltage; and
turning on or off the switching transistor based on a relationship between the feedback signal and the current detection signal.

16. The control method as claimed in claim 15, further comprising:
when the feedback signal is lower than a first threshold voltage, extending the predetermined delay period; and
when the auxiliary voltage rises to exceed a second threshold voltage, beginning delaying the predetermined delay period.

17. The control method as claimed in claim 15, further comprising:
when the feedback signal is lower than a third threshold voltage, ending the zero-voltage switching period;
wherein when output power of the output voltage falls, the feedback signal falls accordingly.

18. The control method as claimed in claim 13, further comprising:
determining whether the auxiliary voltage is at a valley within a delay period after the predetermined delay period;
when it is determined that the auxiliary voltage is at the valley, beginning the zero-voltage switching period; and
when it is not determined that the auxiliary voltage is at the valley within the delay period, beginning the zero-voltage switching period when the delay period ends.

19. The control method as claimed in claim 18, wherein the step of determining whether the auxiliary voltage is at the valley within the delay period after the predetermined delay period further comprises:
determining whether the auxiliary voltage is lower than a fourth threshold voltage; and
when the auxiliary voltage is lower than the fourth threshold, determining the auxiliary voltage is at the valley.

20. The control method as claimed in claim 12, wherein the other terminal of the auxiliary coil generates a supply voltage;
wherein the power conversion circuit further comprises a control circuit, and the control circuit is configured to execute the control method;
wherein the supply voltage is configured to power the control circuit;
wherein the step of turning off the switching transistor to demagnetize the transformer further comprises:
powering the output voltage by the secondary coil;
turning on the auxiliary transistor; and
when the auxiliary transistor is turned on, powering the supply voltage by the auxiliary coil;
wherein the supply voltage is the output voltage multiplied by a turns ratio;
wherein the turns ratio is a number of tuns of the auxiliary coil divided by a number of turns of the secondary coil.
